(19) United States
(12) Patent Application Publication
(10) Pub. No.: US 2008/0232842 A1
(43) Pub. Date: Sep. 25, 2008

(54) Image forming apparatus, image forming system and control method of image forming apparatus

(75) Inventor: Mikimasa Honma, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KONICA MINOLTA BUSINESS TECHNOLOGIES, INC.

(21) Appl. No.: 11/889,361

(22) Filed: Aug. 13, 2007

(30) Foreign Application Priority Data
Sep. 15, 2006 (JP) 2006-251201

(51) Int. Cl. G03G 15/00

(52) U.S. Cl. 399/81

(57) ABSTRACT

Disclosed an image forming apparatus which has a plurality of functions, including: a display section to display operation screens corresponding to the respective plurality of functions; an operation section; a function group storage section to store a function group consisting of a plurality of functions related to one another among the plurality of functions; and a control section to display on the operation screen, when an operation screen corresponding to one function in the function group stored in the function group storage section is displayed, that the image forming apparatus has the remaining function in the function group.

### BACKGROUND

1. Field of the Invention

The present invention relates to an image forming apparatus, an image forming system and a control method of an image forming apparatus wherein a display section displays, when one function in a function group composed of related functions is used, other functions in the function group is included in the apparatus.

2. Description of Related Art

Conventionally, a technique for an image forming apparatus has been known by which a display by a display section is performed in consideration of the usage of a function by a user. For example, a technique according to which, in an image forming apparatus for performing an image forming processing by a function corresponding to an arbitrary key selected by a user, the size, layout, color, or the like of keys displayed on a display section is changed depending on the number of use of the respective keys is disclosed (for example, see Japanese Laid-Open Publication No. 2004-348085 discloses). A technique according to which the usage history of functions is previously stored so that a newly used function is displayed on a first selection screen is also disclosed (for example, see Japanese Laid-Open Publication No. 2005-246900).

By the way, an image forming apparatus includes various functions. However, such functions included in the image forming apparatus may not be recognized by a user. For example, there may be a case where a new function added by an updated control program is poorly communicated by a service person and thus a user still uses the apparatus while being prevented from knowing the new function. There also may be a case where a user does not recognize not only the existence of a new function but also the existence of a function that the user has never used.

For example, functions included in an image forming apparatus include a front-back adjustment function. This front-back adjustment function outputs an exclusive chart to measure and input a required item to adjust the magnification and timing of front and back images. Prior to the advent of this function, a user desiring to perform a front-back adjustment has manually performed the front-back adjustment a little bit at a time by a magnification adjustment by a magnification adjustment function and a timing adjustment by a shift function. A user notifying of the addition of the front-back adjustment function can use the front-back adjustment function to efficiently perform the front-back adjustment. However, a user not knowing this added function uses a conventional magnification adjustment function or shift function to perform a front-back adjustment and thus difficulty notices the existence of the front-back adjustment function.

Conventionally, a function frequently used by a user has been displayed in a highlighted manner or in a prioritized manner as disclosed in the above patent publications. However, a function not used generally has a lower priority or is deleted. This has caused a problem in which a user is prevented from recognizing a function that the user has never used to fail to efficiently use the functions of an image forming apparatus.

### SUMMARY

It is an object of the present invention to allow a user to recognize a function that is included in an image forming apparatus and that is not used.

To realize at least one of the abovementioned objects, an image forming apparatus according to one embodiment that reflects one of aspects of the present invention is an image forming apparatus which has a plurality of functions, including: a display section to display operation screens corresponding to the respective plurality of functions; an operation section; a function group storage section to store a function group consisting of a plurality of functions related to one another among the plurality of functions; and a control section to display on the operation screen, when an operation screen corresponding to one function in the function group stored in the function group storage section is displayed, that the image forming apparatus has the remaining function in the function group.

According to the image forming apparatus, when an operation screen corresponding to a certain function is displayed, it is displayed, on the operation screen, that a function related to the certain function is included in the apparatus. Thus, a user trying to use the certain function can recognize that the function related to the certain function is included in the apparatus, thus improving the convenience for the use of the function.

Preferably, in the image forming apparatus, the control section deletes the function group selected on the operation section among the function group registered in the function group storage section.

Thus, when a user recognizes a related function and thus does not require the display thereof, the related function can be prevented from being displayed.

Preferably, in the image forming apparatus, the control section registers a plurality of functions selected on the operation section as the function group in the function group storage section.

According to the invention, a user can select and register the function group on the operation section.

Preferably, in the image forming apparatus, the control section judges whether or not the function group including one function selected on the operation section is registered in the function group storage section, and when the function group is registered, the control section displays information showing that the image forming apparatus has a remaining function in the function group along with the operation screen of the selected function on the display section.

According to the invention, the display section can display that the remaining function of the function group including the selected function with the operation screen of the function selected by a user.

An image forming system that reflects one of aspects of the present invention is an image forming system including a plurality of image forming apparatuses having a plurality of functions and a server, the plurality of image forming apparatuses and the server being connected to one another via communication network, wherein: each of the image forming apparatuses includes: a display section to display an operation screen corresponding to the respective plurality of functions a usage history storage section to store a usage history of the functions; a transmission section to transmit the usage history stored in the usage history storage section along with identification information about the image forming apparatus to the server; a control section to store, in a function group storage section, in accordance with a registration instruction from the server, information indicating a function group which is instructed to be registered and functions which are not found in the usage history of the image forming apparatus among functions in the instructed function group, and to display, on the operation screen, when an operation screen corresponding to one function in the function group registered in the function group storage section is displayed, that the image forming apparatus has the remaining function in the function group that is not found in the usage history of the image forming apparatus, and the server includes: a reception section to receive the identification information and the usage history from the plurality of image forming apparatuses; a control section to extract, based on the received usage history of the plurality of image forming apparatuses, a function group consisting of a plurality of functions that are used in relation to one another, and to search a function included in the extracted function group on the usage history received from the respective image forming apparatuses to issue, when the function is not found in the received usage history, the registration instruction for instructing the corresponding image forming apparatus to register, in the function group storage section, the extracted function group and functions of the extracted function group that are not found in the received usage history.

According to the image forming system, when the operation screen corresponding to a certain function is displayed, the operation screen displays an existence of the function used in another image forming apparatus on the communication network while having a relation with the certain function and that is not used in the image forming apparatus. Thus, a user trying to use a certain function can recognize an existence of a function used in another image forming apparatus on the communication network while having a relation with the certain function and that is not used by the user, thus improving the convenience for the use of the function.

Preferably, in the image forming system, the control section of the image forming apparatus searches whether or not all functions included in each of function groups stored in the function group storage section is included in the usage history in the usage history storage section, and when the all functions in the function group is included in the usage history, deletes the function group from the function group storage section.

According to the invention, a function that is recognized by a user and that is used by the user is automatically prevented from being displayed. Thus, an unnecessary display can be prevented.

A control method of an image forming apparatus that reflects one of aspects of the present invention is a control method of an image forming apparatus which has a plurality of functions and a display section to display operation screens corresponding to the respective plurality of functions, including: registering a function group consisting of a plurality of functions related to one another among the plurality of functions; and displaying on the operation screen, when an operation screen corresponding to one function in the function group registered in the function group storage section is displayed, that the image forming apparatus has the remaining function in the function group.

According to the control method of the image forming apparatus, when an operation screen corresponding to a certain function is displayed, it is displayed, on the operation screen, that a function related to the certain function is included in the apparatus. Thus, a user trying to use the certain function can recognize that the function related to the certain function is included in the apparatus, thus improving the convenience for the use of the function.

Preferably, the control method further comprising: deleting, the function group selected on the operation section among the function group registered in the function group storage section.

According to the invention, when a user recognizes a related function and thus does not require the display thereof, the related function can be prevented from being displayed.

### BRIEF DESCRIPTION OF THE DRAWINGS

The present invention will become more fully understood from the detailed description given hereinbelow and the appended drawings, and thus are not intended as a definition of the limits of the present invention, and wherein:

FIG. 1 is a block diagram illustrating a functional configuration of an image forming apparatus according to the present invention.

FIG. 2A shows an example of storage of data of a function group table of FIG. 1.

FIG. 2B shows an example of the function group table of FIG. 2A in which additional data is registered.

FIG. 3 is a flowchart illustrating a control program update processing executed by the control section of FIG. 1.

FIG. 4A shows an example of a function group registration/deletion screen displayed on an operation display section of FIG. 1.

FIG. 4B shows an example of a related function selection screen displayed on the operation display section of FIG. 1.

FIG. 5 is a flowchart illustrating a related function display processing executed by the control section of FIG. 1.

FIG. 6 shows an example of the display of an operation screen corresponding to a front face longitudinal magnification adjustment function, a back face longitudinal magnification adjustment function, a front face lateral magnification adjustment function, and a back face lateral magnification adjustment function displayed on the operation display section of FIG. 1.

FIG. 7 shows an example of the entire structure of an image forming system according to a second embodiment of the invention.

FIG. 8 is a block diagram illustrating a functional configuration of a server of FIG. 7.

FIG. 9 shows an example of the storage of data in a registered table of FIG. 8.

FIG. 10 is a flow diagram illustrating a function group registration processing executed between a server of the image forming system of FIG. 7 and the image forming apparatus.

FIG. 11A shows an example of the storage of data in a usage history file stored in storage section of image forming apparatus 1A of FIG. 7.

FIG. 11B shows an example of the storage of data in a usage history file stored in storage section of image forming apparatus 1B of FIG. 7.

FIG. 12A shows an example of the storage of data in a usage history file stored in the storage section of image forming apparatuses 1C of FIG. 7.

FIG. 12B shows an example of the storage of data in a usage history file stored in the storage section of image forming apparatuses 1D of FIG. 7.

FIG. 13 schematically illustrates the result of the grouping of functions used within 30 minutes based on the respective usage history files shown in FIGS. 11A, 11B, 12A and 12B.

FIG. 14 is a flowchart illustrating a function group deletion processing executed by the control section of FIG. 1.

### DETAILED DESCRIPTION OF THE PREFERRED EMBODIMENT

Hereinafter, a first embodiment and a second embodiment of the present invention with reference to the drawings will be described. The scope of the invention is not limited to examples shown in the drawings.

### Embodiment 1

First, the structure will be described.

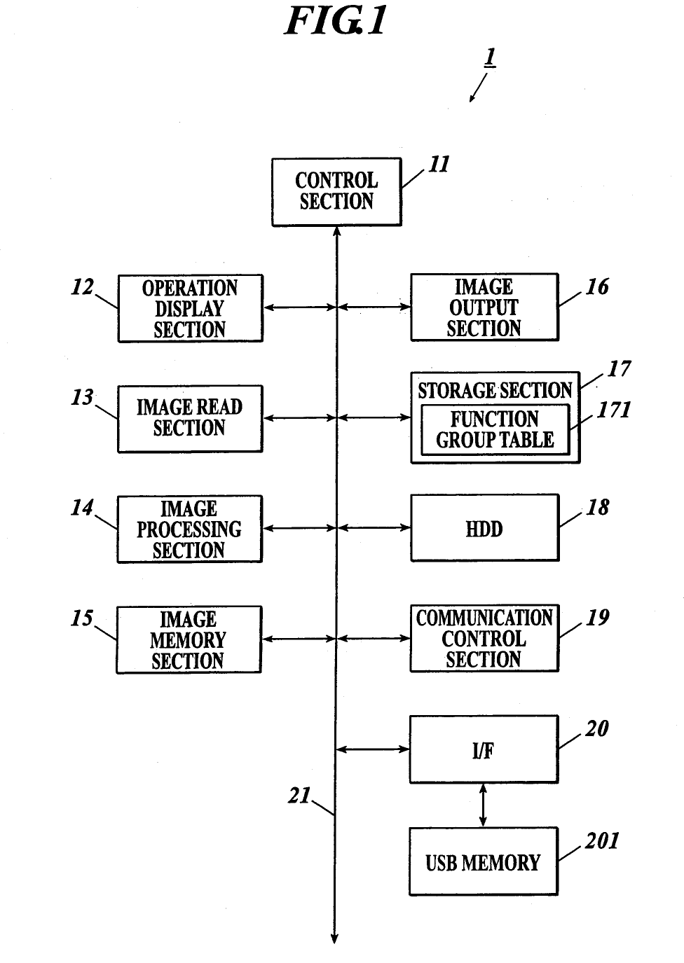

FIG. 1 is a block diagram illustrating functional configuration of an image forming apparatus 1 according to the first embodiment of the invention. The image forming apparatus 1 is structured to include, as shown in FIG. 1, a control section 11, an operation display section 12 An image read section 13, an image processing section 14, an image memory section 15, an image output section 16, a storage section 17, a HDD 18, a communication control section 19, and an I/F 20 for example. The respective components are connected by a bus 21.

The control section 11 is composed by a Central Processing Unit (CPU), a Random Access Memory (RAM), and the like for example. The CPU of the control section 11 reads a control program or the like stored in the storage section 17 to expand the program in a work area formed in the RAM to control the respective sections based on the expanded program.

The operation display section 12 is composed by a Liquid Crystal Display (LCD) to provide, based on an instruction by a display signal inputted by the control section 11, displays on a display screen such as a basic screen, operation screens corresponding to various functions, a display of a status of the apparatus, or the operation statuses of the respective functions. The display screen of the LCD is covered by a pressure sensitive type (resistive film type) touch panel in which transparent electrodes are arranged in a matrix. The display screen as an operation section detects, as a voltage value, X and Y coordinates of a point depressed by a finger or a touch pen for example to output the detected position signal as an operation signal to the control section 11. The operation display section 12 Also includes various operation buttons (e.g., numeric button, start button) to output an operation signal by the operation of a button to the control section 11.

The basic screen is a screen to display items (function items) of functions which the image forming apparatus 1 has. When a user selects, from among displayed function items, a function item corresponding to a function that the user desires to use to depress the function item, an operation screen corresponding to the selected function is displayed on the operation display section 12.

The image read section 13 is structured so that a lower part of a contact glass on which an original document is placed includes a scanner to read an image of the document. The scanner is structured by a light source, a Charge Coupled Device (CCD) or the like. The scanner light source images reflection light of light irradiating and scanning the document to subject the image to a photoelectric conversion to read the image of the document. An A/D converter converts the read image to digital image data to output the digital image to the image processing section 14.

The image processing section 14 subjects image data inputted from the image read section 13 to an image processing such as spatial filter processing, enlargement/reduction processing, rotation processing, and tone correction processing. The image processing section 14 also converts a printer code inputted from the communication control section 19 to image data to output the image data to the image memory section 15.

The image memory section 15 is structured to include an image memory composed by a Dynamic Random Access Memory (DRAM) or the like and a compression/decompression IC. Based on the control of the control section 11, the image memory section 15 compresses image data inputted from the image processing section 14 to store the image in an image memory. The image memory section 15 also decompresses, based on the control of the control section 11, the image data stored in the image memory.

The image output section 16 is a printer engine that has; a tray to be filled with recording media; a recording medium carrying apparatus; a photoconductive drum; a charging apparatus; a laser unit; a development apparatus; a transfer/separation apparatus; a cleaning apparatus; a fixing apparatus; and a post-processing apparatus. The image output section 16 uses an electronograph process to form an image corresponding to image data on a recording medium to output the image.

The storage section 17 is composed by a non-volatile semiconductor memory or the like and previously stores a control program corresponding to the image forming apparatus 1 and various pieces of data used by the control program for example. A control program includes various processing programs such as a control program update program for executing a control program update processing or a related function display processing program for executing a related function display processing.

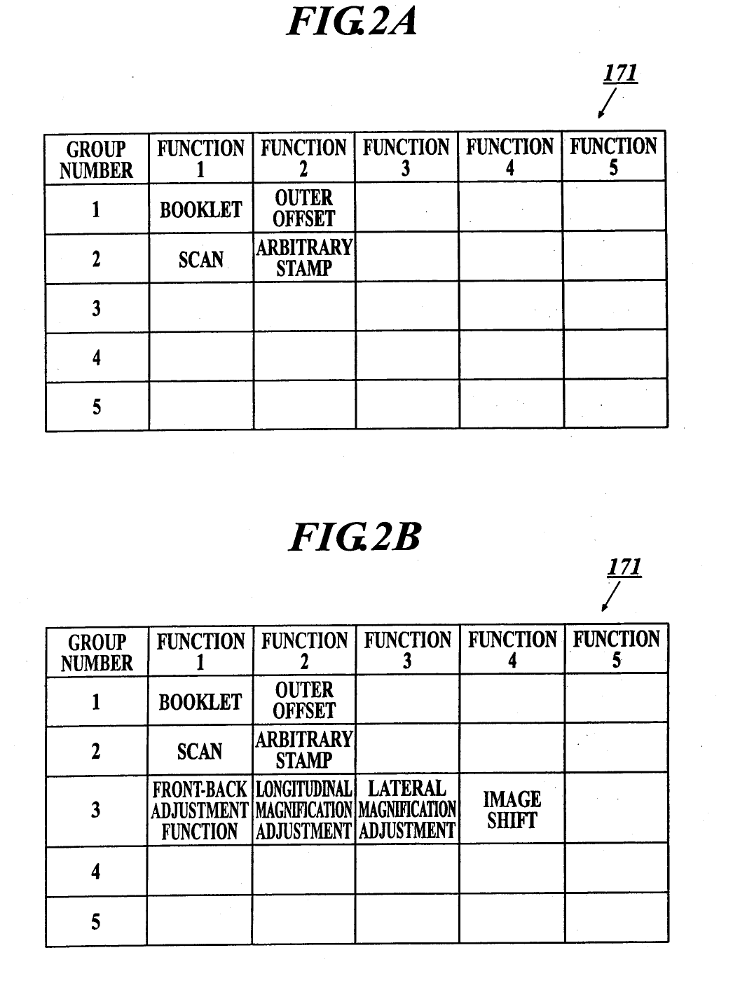

The storage section 17 stores the function group table 171 as a function group storage section. FIGS. 2A and 2B show an example of the function group table 171. The function group table 171 is a table for registering a function group obtained by grouping related functions among a plurality of functions which the image forming apparatus 1 has. As shown in FIGS. 2A and 2B, the function group table 171 stores data of group numbers for identifying function groups and data showing the respective functions belonging to the function groups (or constituting the function groups) that are identified by the group numbers.

The term “related function” means, for example, another function that must be used together with one function when the one function is used or that can improve the performance of the one function or a user convenience when it is used together with one function.

For example, an “outer offset” function is a function to equalize the widths of margins of left and right pages of an opened booklet prepared by a “booklet” function. The “booklet” function and the “outer offset” function are a related function. An “arbitrary stamp” function is a function to add, to image data scanned by the image read section 13, a stamp image showing a date, a company name or the like. A “scan” function and the “arbitrary stamp” function are a related function.

Functions include various setting functions such as a tray setting function to set the respective trays with regards to paper types, paper sizes.

Returning to FIG. 1, a Hard disk (HDD) 18 stores therein image data.

A communication control section 19 is an interface that can be connected to a transmission medium connected to a communication network such as Local Area Network (LAN), Wide Area Network (WAN), or the Internet. The communication control section 19 is composed by a network card or the like for example and transmits and receives various pieces of data (e.g., control signal, printer code) to or from an external apparatus connected to a communication network (e.g., host apparatus).

The I/F 20 is an interface for transmitting and receiving data between the CPU of the control section 11 and an external apparatus connected to the I/F 20. In this embodiment, a Universal Serial Bus (USB) memory 201 as a portable memorize medium can be attached to or detached from the I/F 20. When the USB memory 201 is attached to the I/F 20, the I/F 20 transmits and receives data between the control section 11 and the USB memory 201.

Next, the operation of the first embodiment will be described.

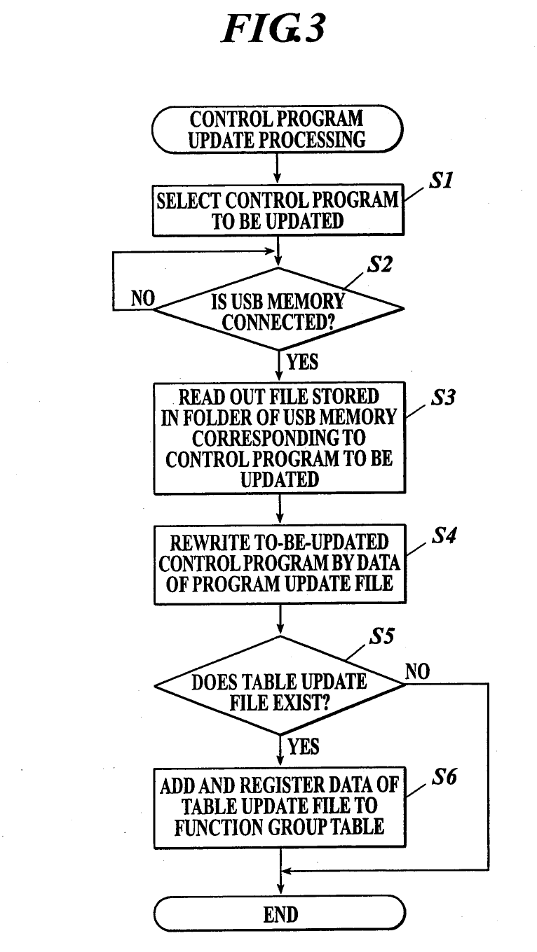

FIG. 3 is a flowchart illustrating a control program update processing executed by the control section 11 when the update of a control program stored in the storage section 17 is instructed via the operation display section 12. This processing is realized by software processing by the cooperation of the control section 11 and a control program update processing program stored in the storage section 17.

First, when a to-be-updated control program is selected from a displayed list of control program name or the like stored in the storage section 17 (Step S1), whether or not the USB memory 201 is connected via the I/F 20 is judged (Step S2). When it is judged that the USB memory 201 is connected (Step S2; YES), a file in a folder stored in the USB memory 201, corresponding to a selected control program as a subject of update is read out, and the file is temporarily stored in the RAM of the control section 11 (Step S3).

The USB memory 201 is set by a manufacturer to previously memorize a folder for updating a control program. The update folder here is given with a folder name showing a name of a to-be-updated control program or the like so that the control section 11 can identify an update folder corresponding to a to-be-updated control program. The update folder includes an update file of a control program (program update file). When a new function is added by the update of a control program, a table update file is included in the update folder. The table update file is data to add a function group consisting of the new function and a function related to the new function to the function group table 171.

Next, the data of the read program update file is used to rewrite a to-be-updated control program stored in the storage section 17 (Step S4). Next, whether or not the read file includes a table update file is judged and, when it is judged that the read file does not include a table update file (Step S5; NO), this processing is completed. When it is judged that the read file includes a table update file (Step S5; YES), based on the data of the table update file, a new function group is added to and registered in the function group table 171 (Step S6), thereby completing this processing. Specifically, Step S6 issues a group number for identifying a newly added function group. The data of the table update file associated with the group number is written to the function group table 171.

By the above control program update processing, when a new function is added by the update of a control program, a function group consisting of the new function and a function related to the new function is automatically added to and registered in the function group table 171.

When the function group table 171 of a control program prior to update is the one as shown in FIG. 2A for example and when the above control program update processing updates the control program to add a front-back adjustment function, a function group as shown in FIG. 2B that consists of the front-back adjustment function and a function related to the front-back adjustment function (specifically, a front-back adjustment, a longitudinal magnification adjustment, and a lateral magnification adjustment, image shift) is added to and is registered in the table.

It is noted that the above control program update processing is a mere example and another method also may be used to perform an update. For example, an update file for a control program or a table update file also may be downloaded via the Internet or the like.

Registration of a function group is not performed only when a control program is updated. A user may appropriately register a function group on the function group registration/deletion screen 121 of the operation display section 12 in a free manner. Alternatively, a function group composed of functions that are all recognized by a user for example and thus is not required to be displayed also can be deleted from the function group table 171 via the screen 121.

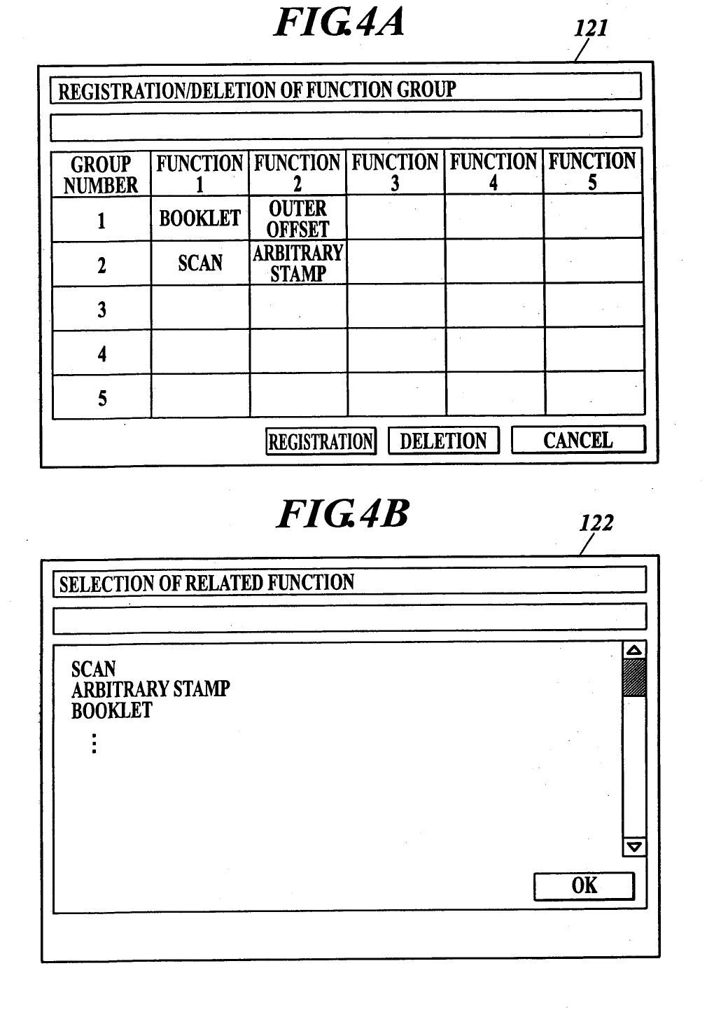

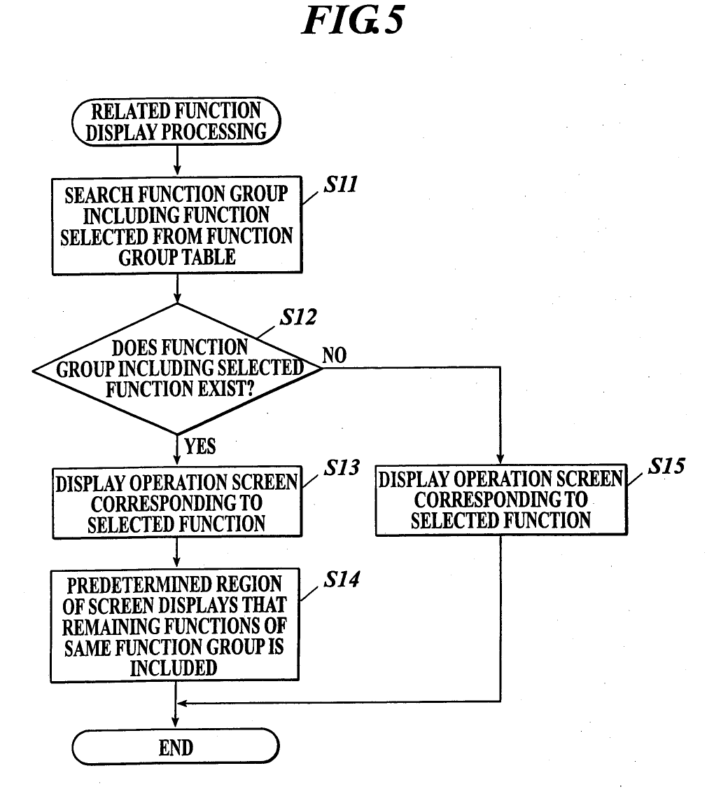

FIG. 4A shows an example of the function group registration/deletion screen 121. When a predetermined operation of the operation display section 12 instructs the function group registration/deletion screen 121 to be displayed, the control section 11 reads the function group table 171 into a RAM and the operation display section 12 displays the function group registration/deletion screen 121 displaying the contents of the read function group table 171, a registration button, a deletion button or the like. When the registration button of the function group registration/deletion screen 121 is depressed, the control section 11 controls the operation display section 12 to display a related function selection screen 122 shown in FIG. 4B. When a related function is selected through this related function selection screen 122 by depressing function items of a plurality of functions relating to one another and an OK button is depressed, the control section 11 causes a function group consisting of the selected plurality of functions to be added and registered in the function group table 171. Specifically, a group number for identifying a newly added function group is issued and the respective selected functions associated with the group number are written to the function group table 171. When a group number of a to-be-deleted function group is depressed and the deletion button is depressed through the function group registration/deletion screen 121, the control section 11 causes data of the function group of the depressed group number to be deleted from the function group table 171.

Next, a related function display processing will be described that is executed by the control section 11 when one function is selected and operated on the operation display section 12. FIG. 5 is a flowchart illustrating a related function display processing. This processing is realized by software processing by the cooperation of the control section 11 and a related function display processing program stored in the storage section 17.

First, selection operation of one function is received on the operation display section 12 (Step S10), and a searching processing of a function group including a selected function is performed in the function group table 171 (Step S11). When the search result shows a function group including the selected function (Step S12; YES), an operation screen corresponding to the selected function (e.g., a screen through which detailed setting for the selected function is performed or execution of the function is instructed) is displayed on the operation display section 12 (Step S13), and a predetermined region of the operation screen corresponding to the selected function displays that the apparatus has the remaining functions in the same functional group as that of the selected function (Step S14), thereby completing this processing. When the search result does not show a function group including the selected function (Step S12; NO) on the other hand, an operation screen corresponding to the selected function is displayed on the operation display section 12, (Step S15), thereby completing this processing.

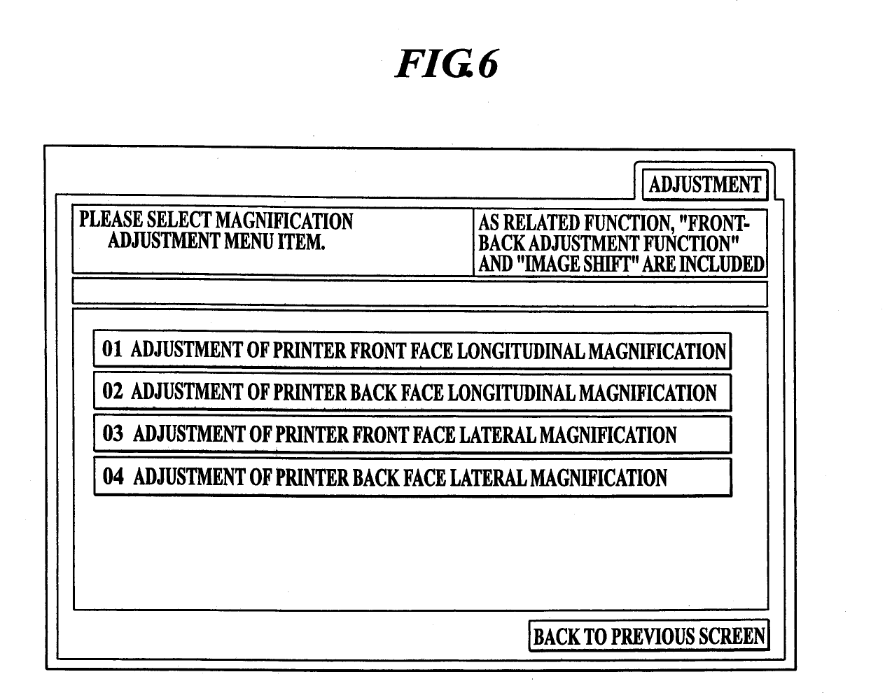

FIG. 6 shows an example of an operation screen displayed on the operation display section 12 in Step S14. As shown in FIG. 6, the upper right corner of the screen displays that the apparatus has the remaining functions in the same functional group as that of the selected function.

As described above, according to the image forming apparatus 1 of this embodiment, when one function is selected through the operation display section 12A function group including the selected function is searched in the function group table 171 in which function groups composed of related functions are registered. When the search result shows an existence of a function group including the selected function, an operation screen corresponding to the selected function is displayed and the operation screen displays that the apparatus has the remaining functions in the same functional group as that of the selected function. Thus, when a user uses a certain function, the user can recognize that the apparatus has a function related to the function, thereby improving convenience. When a new function is added by an update of a control program, a function group consisting of the new function and a function related to the new function is also added to and is registered in the function group table 171. Thus, the user trying to use an existing function can recognize that a new function related to this existing function is added. Furthermore, a new function group can be added to and can be registered in the function group table 171 through the operation display section 12. Thus, a related function known to a very limited number of users can be shared by all users. Furthermore, a no-more-required function group also can be deleted from the function group table 171 through the operation display section 12. Thus, when a user recognizes a related function and does not requires the display of the related function, the related function can be prevented from being displayed.

### Embodiment 2

Next, the second embodiment of the present invention will be described.

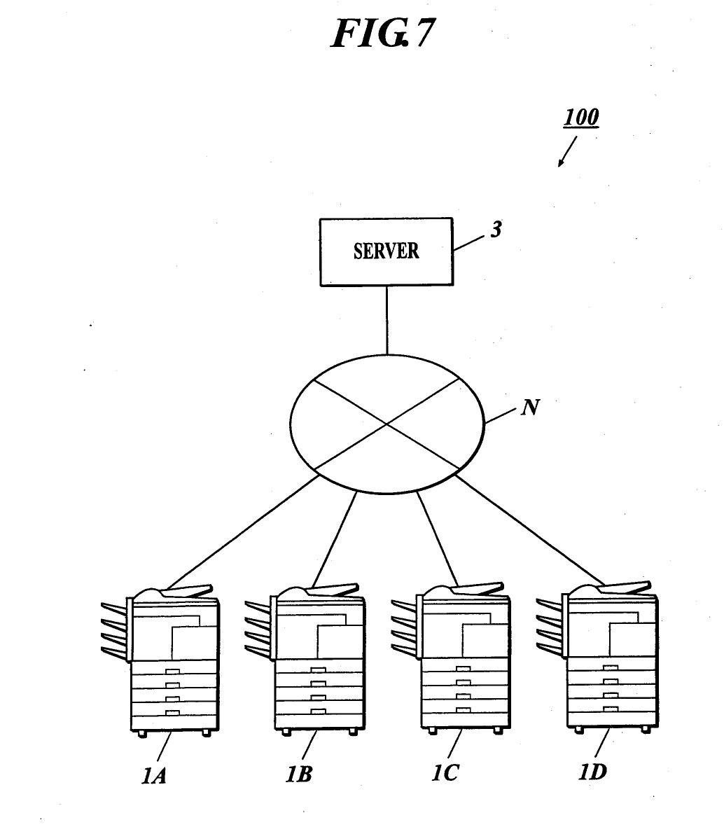

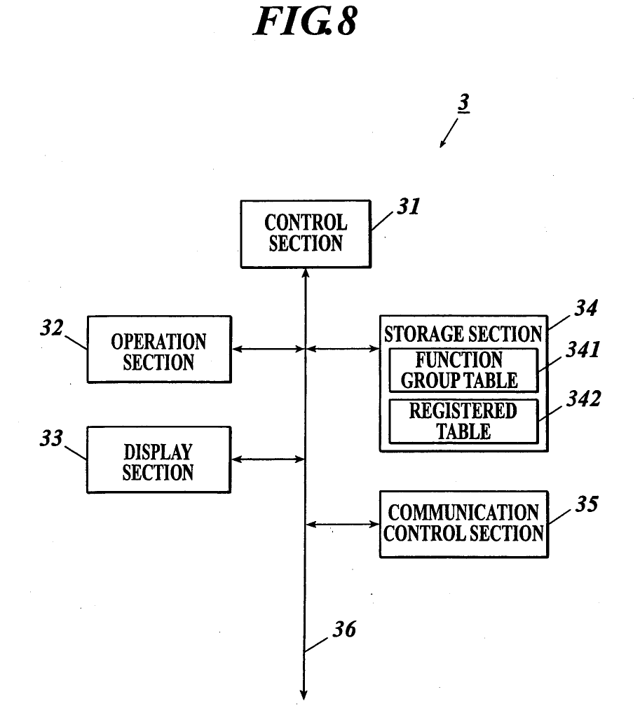

FIG. 7 shows the entire structure of an image forming system 100 in the second embodiment. As shown in FIG. 7, the image forming system 100 is structured so that a plurality of image forming apparatuses 1 and a server 3 are connected via a communication network N such as Local Area Network (LAN), Wide Area Network (WAN), and the Internet so as to transmit and receive data therebetween. The respective image forming apparatuses 1 connected to the communication network N are given with unique identification IDs so that the respective image forming apparatuses 1 can be identified on the communication network N. It is noted that the second embodiment will be described for a case in which four image forming apparatuses 1 (image forming apparatuses 1A to 1D) are connected in the system but the number of the image forming apparatuses 1 is not particularly limited.

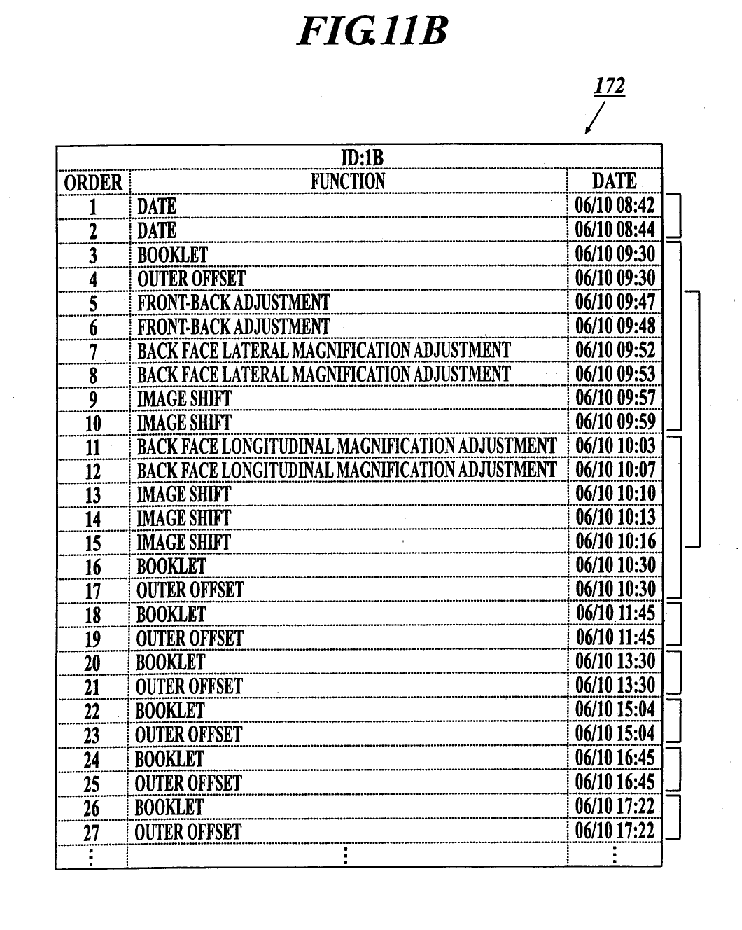

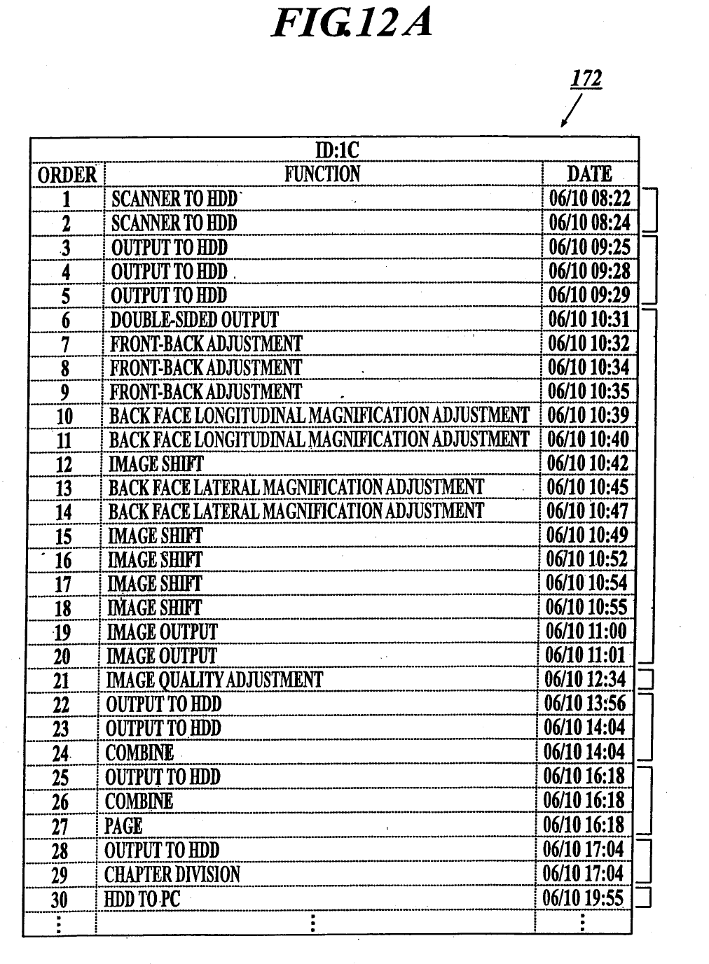

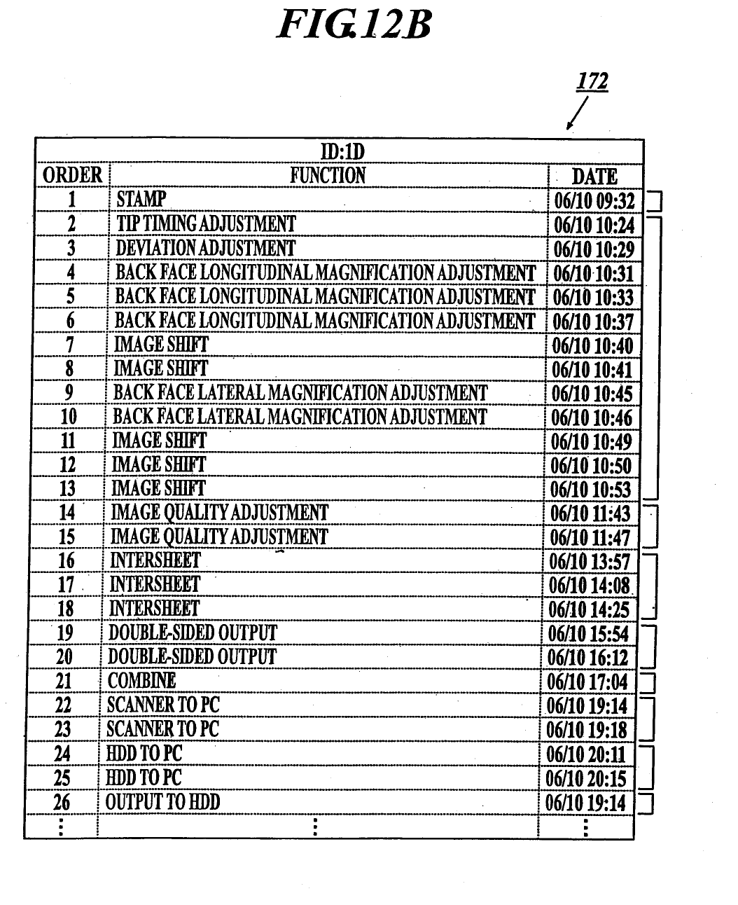

In the second embodiment, the storage section 17 of the image forming apparatus 1 stores a function group registration processing (apparatus-side) program, a related function display processing program, and a function group deletion processing program. The storage section 17 also functions as a usage history storage section that stores a usage history file 172 in which a function used within a fixed period and a date at which the function is used are recorded so that the function and the date are associated with each other (see FIGS. 11A, 11B, 12A, 12B). The control section 11 has a usage history recording function by which, when it is instructed to execute any of functions through the operation display section 12 And the function is used, information showing the used function and a date at which the function is used (or a date at which the execution is instructed) is recorded in the usage history file 172. The control section 11 also includes a Real Time Clock (RTC) (not shown) and acquires current date information and time information.

The other structures of the image forming apparatus 1 are the same as those described with reference to FIG. 1 and thus will not be described further.

FIG. 8 is a block diagram illustrating a functional configuration of the server 3. As shown in FIG. 8, the server 3 is structured to include a control section 31, an operation section 32, a display section 33, a storage section 34, and a communication control section 35 or the like. The respective sections are connected via a bus 36.

The control section 31 is composed by a Central Processing Unit (CPU) and a Random Access Memory (RAM) or the like. The CPU of the control section 11 reads a program stored in the storage section 34 to expand the program into a work area formed in the RAM to control the respective components based on the expanded program.

The operation section 32 is structured by a keyboard including a cursor key, numeric input keys, and various function keys or the like as well as a pointing device (e.g., mouse). The operation section 32 outputs a depression signal generated by key depressing operation in the keyboard and an operation signal generated by the mouse to the control section 31 as an input signal.

The display section 33 is structured to include, for example, a monitor (e.g., Cathode Ray Tube (CRT), Liquid Crystal Display (LCD)). The display section 33 displays various screens based on an instruction by a display signal inputted from the CPU 31.

The storage section 34 is composed by a Hard Disc (HDD) or a non-volatile semiconductor memory or the like.

The storage section 34 stores various programs such as a system program corresponding to the control section 31 and a function group registration processing (server-side) program.

The storage section 34 also stores, as shown in FIG. 8, a function group table 341 and a registered table 342.

The function group table 341 has the same structure as that shown in FIGS. 2A and 2B, and stores functions belonging to the function group identified by the group number to be associated with the group number for identifying the function group.

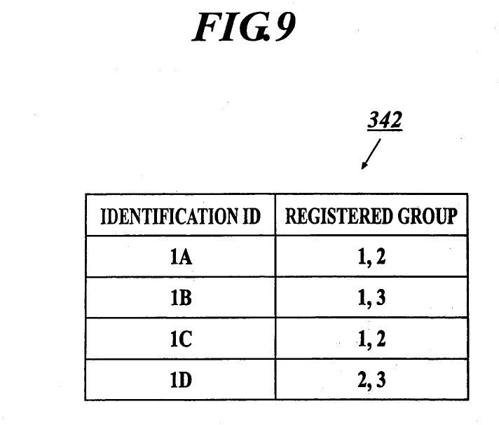

As shown in FIG. 9, the registered table 342 stores identification IDs of the respective image forming apparatuses 1 connected to the communication network N to be associated with group numbers of function groups registered in the respective image forming apparatuses 1. It is noted that group numbers of the registered table 342 correspond to group numbers of function group table 341.

The communication control section 35 is composed by a network card and the like to communicate with an external device so as to communicate with a device connected to the communication network N.

Next, the operation of the second embodiment will be described.

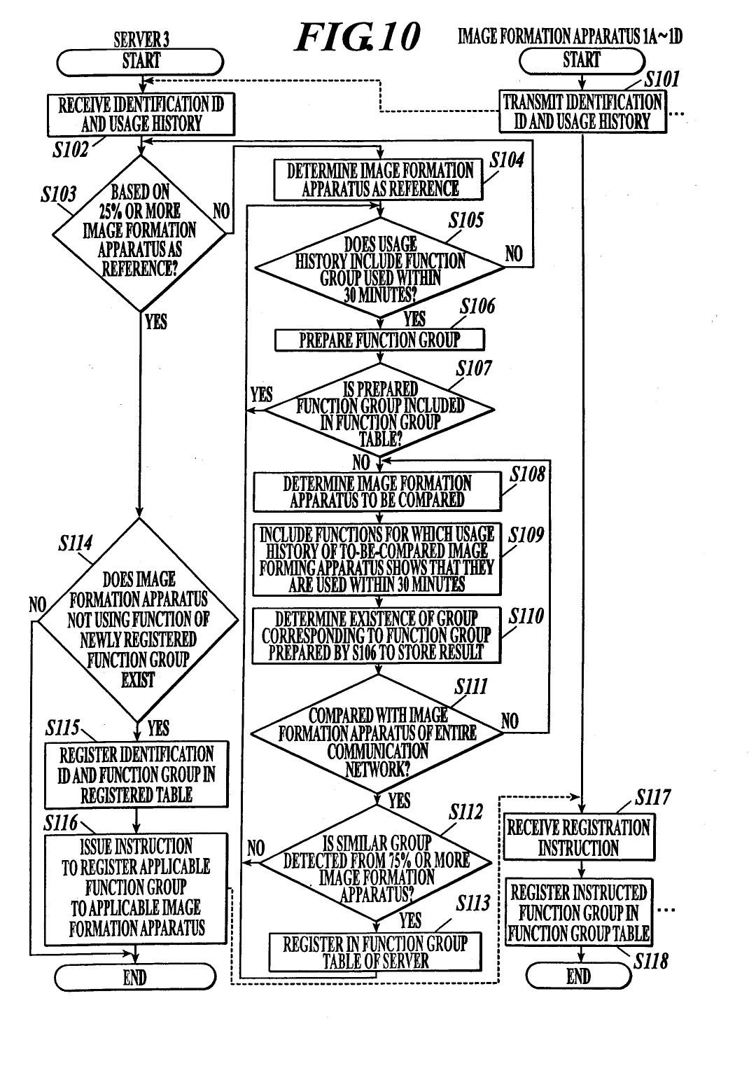

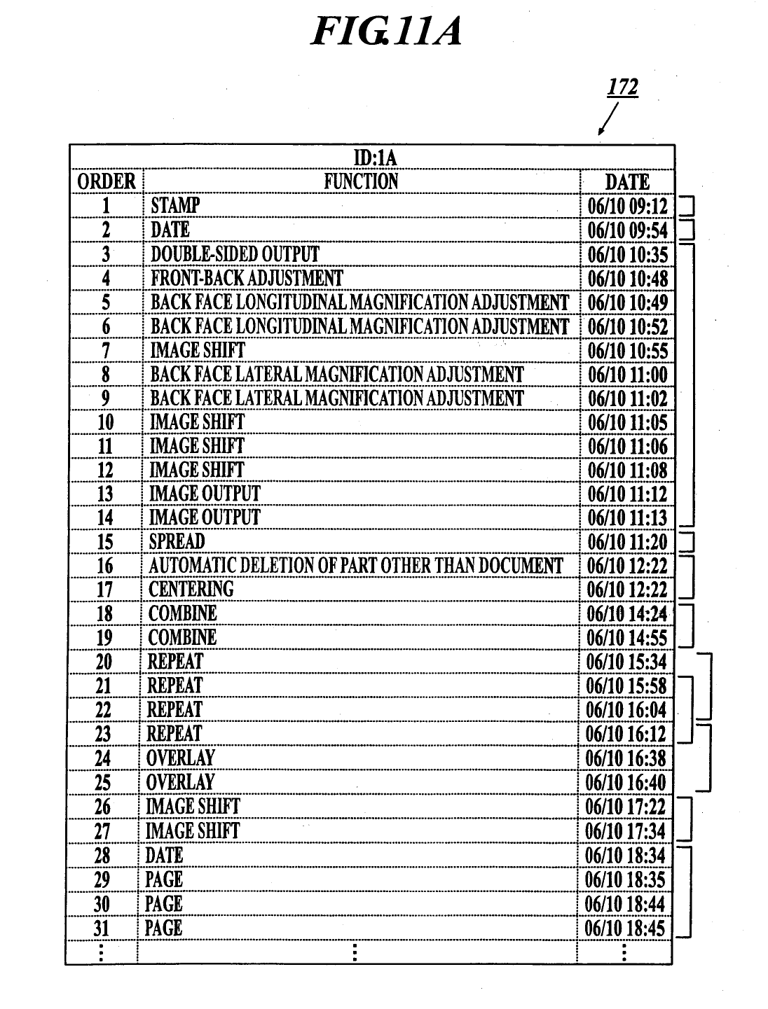

FIG. 10 is a flow diagram illustrating a function group registration processing executed by the image forming system 100. An image forming apparatus 1—side processing shown in FIG. 10 is a processing that is realized, in the respective image forming apparatuses 1A to 1D, by the cooperation between the control section 11 and a function group registration processing (apparatus-side) program. A server 3—side processing is a processing that is realized by the cooperation between the control section 31 and a function group registration processing (server-side) program. This function group registration processing is performed when a predetermined time is reached. It is assumed that the times of the respective apparatuses in the image forming system 100 are synchronized to one another. It is noted that, although FIG. 10 shows only one image forming apparatus 1—side processing and does not show the other processings, the image forming apparatus 1—side processings are performed by the image forming apparatuses 1A to 1D in a parallel manner.

First, each of the apparatuses of the image forming apparatuses 1A to 1D reads a usage history file 172 stored in the storage section 17 and the communication control section 19 as the transmission section transmits an identification ID of the apparatus concerned and the usage history file 172 to the server 3 (Step S101).

The server 3 receives the identification ID and the usage history file 172 sent from each of the image forming apparatuses 1A to 1D via the communication control section 35 as the reception section (Step S102). When the server 3 receives the identifications ID and usage history files 172 from all image forming apparatuses 1 of the image forming apparatuses 1A to 1D, the server 3 extracts function groups based on the received usage history files 172 of the plurality of image forming apparatuses 1. FIGS. 11A and 11B as well as FIGS. 12A and 12B illustrate examples of usage history files 172 sent from the image forming apparatuses 1A to 1D.

The term “function group” means a group of related functions as described in the first embodiment. The term “related function” means a function used together with a certain function, i.e. a function used with a certain function while the certain function is used. The function includes various setting function such as a tray setting function to set the respective trays with regards to a paper type, a paper size or the like.

The server 3 extracts a function group in the manner as described below. First, the server 3 determines one of a plurality of the image forming apparatuses 1A to 1D as the image forming apparatus 1 as a reference. Then, functions used in the usage history file 172 of the image forming apparatus 1 as a reference within a predetermined time (30 minutes in this case) are collected in a group to prepare a function group. When the prepared function group is not registered in the function group table 341 yet, whether or not the same function group can be detected from a usage history file 172 of another image forming apparatus 1 is checked. When a detection rate is equal to or more than a predetermined percent (75 percent in this case), the function group is registered in the function group table 341. These processings are performed based on a predetermined percent or more of all of the image forming apparatuses 1 connected to the apparatuses communication network N (25 percent in this case) as a reference. This extraction processing functions are realized by execution of processings of Steps S103 to S113 of FIG. 10 in the server 3.

First, whether or not functional groups are prepared based on 25% or more image forming apparatuses 1 of the image forming apparatuses 1A to 1D connected to the communication network N as a reference is judged. When it is judged that function groups are not formed based on the image forming apparatus 1 of 25% or more as a reference (Step S103; NO), the processing proceeds to Step S104. When it is judged that function groups are formed based on the image forming apparatus 1 of 25% or more as a reference (Step S103; YES), then the processing proceeds to Step S114.

Step S104 determines, from among the image forming apparatuses 1A to 1D, an image forming apparatus as a reference for the formation of function groups. In order to eliminate deviation of image forming apparatuses as a reference, for example, identification IDs of the image forming apparatuses 1 as a reference are stored in a predetermined area of the storage section 34, and Step S104 determines the image forming apparatus 1 having an identification ID next to the stored identification ID as an image forming apparatus as a reference. Alternatively, the image forming apparatus 1 as a reference also may be selected at random so that the image forming apparatus 1 as a reference can be selected again when duplication caused in a single function group registration processing is caused.

Next, the usage history file 172 of the image forming apparatus 1 as a reference is searched from the top to judge whether or not there is functions used within 30 minutes. When it is judged that functions used within 30 minutes exists (Step S105; YES), the searched functions are included in a group to prepare a function group (Step S106). It is noted that, even when the functions are used within 30 minutes, if there is a predetermined time or more interval (e.g., 10 minutes or more) between uses of the one function and the other functions, the one function and the other function are difficulty judged that they are used related to one another. Thus, Step S105 in this case judges whether or not functions that are used within 30 minutes and that are used without a predetermined time interval or more exist. When such functions exist, the functions are included in a group. In this manner, related functions can be included in a group with a higher accuracy.

Step S107 searches a prepared function group from the function group table 341 to judge whether or not the prepared function group exists in the function group table 341. When it is judged that the prepared function group exists in the function group table 341 (Step S107; YES), the processing returns to Step S105. It is noted that, when Step S105 finds functions used within 30 minutes, the subsequent search is stopped and the next processing is started. Thus, when the processing returns to Step S105, the search is started from a part at which the search was previously stopped.

When it is judged that the prepared function group is not included in the function group table 341 (Step S107; NO), then the image forming apparatus 1 to be compared is determined (Step S108). The image forming apparatus 1 to be compared is an image forming apparatus other than the image forming apparatus 1 as a reference and is sequentially selected. Then, it is judged whether or not the image forming apparatus 1 to be compared has the same function group. First, the usage history file 172 having an identification ID of the image forming apparatus 1 to be compared is referred and functions for which the usage history of the image forming apparatus 1 to be compared shows that the functions are used within 30 minutes are included in a function group (Step S109). Next, it is judged whether or not a group corresponding to the function group prepared in Step S106 exists and the judgment result is temporarily stored in the RAM of the control section 31 (Step S110). Next, it is judged whether or not all of the image forming apparatuses 1 other than the image forming apparatus as a reference on the communication network N are compared. When it is judged that an image forming apparatus 1 not yet compared exists (Step S111; NO), the processing returns to Step S108 to subject an image forming apparatus 1 not yet compared to the processings of Steps S108 to S110.

When it is judged that all of the image forming apparatuses 1 other than the image forming apparatus as a reference on the communication network N are compared (Step S111; YES), the judgment result temporarily stored in the RAM in Step S110 is referred to so as to judge whether or not the function group prepared in Step S106 is detected from 75 percent or more image forming apparatuses 1 and, when it is judged that the function group prepared in Step S106 is not detected from 75 percent or more image forming apparatuses 1 (Step S112; NO), the processing returns to Step S105. When it is judged that the function group prepared in Step S106 is detected from 75 percent or more image forming apparatuses 1 (Step S112; YES), the function group is registered in the function group table 341 of the server 3 (Step S113). Specifically, a group number for identifying the function group is issued and data showing functions belonging to the function group that is associated with the group number is written to the function group table 341. Then, the processing returns to Step S105 and processings after Step S105 are performed repeatedly.

When Step S105 judges that the usage history file 172 of the image forming apparatus 1 as a reference shows no functions of one group used within 30 minutes (Step S105; NO), the processing returns to Step S103 and the processings after Step S103 are performed repeatedly. When Step S103 judges that the function group is prepared based on the image forming apparatuses 1 of 25 percent or more as a reference (Step S103; YES), the processing proceeds to Step S114.

It is noted that, when the function group prepared in Step S106 is not detected from 75 percent or more of all of the image forming apparatuses 1, a function group is prepared by a combination of functions obtained by deducting one function from the function group to judge, with regards to each function group, whether or not a function group corresponding to the prepared function group exists in another image forming apparatus 1. When a corresponding function group is detected from 75 percent or more of all of the image forming apparatuses 1, the function group is preferably registered in the function group table 341. When all function groups obtained by deducting one function from the function group prepared in Step S106 are not detected from 75 percent or more of all of the image forming apparatuses 1, a combination of functions obtained by further deducting one function from the function group is used to prepare a function group. Then, each function group is judged with regards to whether or not a function group corresponding to the prepared function group exists in another image forming apparatus 1. When a function group corresponding to the prepared function group is detected from 75 percent or more of all of the image forming apparatuses 1, the function group is preferably registered in the function group table 341. Similarly, it is preferred that, until a function group is detected from 75 percent or more of all of the image forming apparatuses 1, a combination obtained by deducting one function (a combination of at least two different functions) is sequentially prepared to perform the same processing.

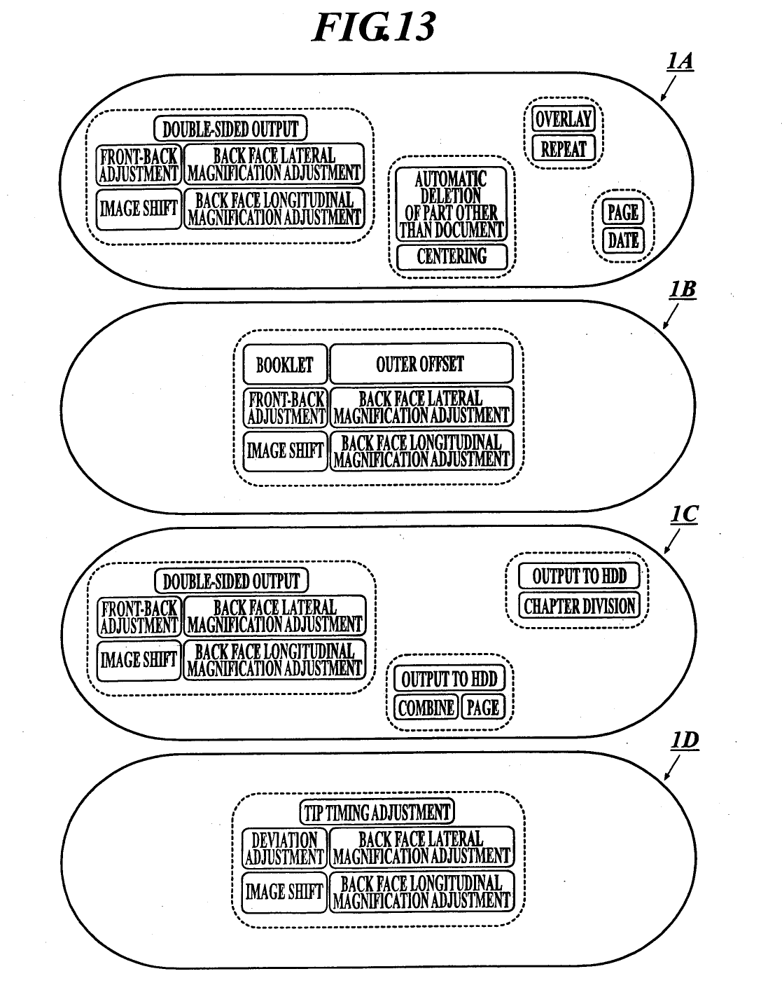

FIG. 13 shows the result of grouping functions used within 30 minutes based on usage history files 172 shown in FIGS. 11A and 11B and FIGS. 12A and 12B (i.e., the respective usage history files 172 sent from the image forming apparatuses 1A to 1D).

When the image forming apparatus 1A is used as a reference for example, the usage history of the image forming apparatus 1A shows function groups of {screen output, front-back adjustment, back face lateral magnification adjustment, image shift, back face longitudinal magnification adjustment} as shown in FIG. 13. Thus, when these function groups are not registered in the function group table 341, the processings of Steps S108 to S109 judges whether or not the image forming apparatuses 1B to 1D have similar function groups. In this case, the above function groups exist only in the image forming apparatus 1C and thus the above function groups are not detected from the image forming apparatuses 1 exceeding 75 percent of all of the image forming apparatuses 1. Then, the following function groups 1 to 5 obtained by deducting one function are obtained.

Group 1: {front-back adjustment, back face longitudinal magnification adjustment, back face lateral magnification adjustment, image shift}
Group 2: {double-sided output, back face longitudinal magnification adjustment, back face lateral magnification adjustment, image shift}
Group 3: {double-sided output, front-back adjustment, back face lateral magnification adjustment, image shift}
Group 4: {double-sided output, front-back adjustment, back face longitudinal magnification adjustment, image shift}
Group 5: {double-sided output, front-back adjustment, back face longitudinal magnification adjustment, back face lateral magnification adjustment}

The image forming apparatuses 1B to 1C have the group 1 as shown in FIG. 13. Thus, the image forming apparatuses 1B to 1C and the image forming apparatus 1A occupy 75 percent or more of all of the image forming apparatuses. Thus, the group 1 is registered in the function group table 341 of the server 3 as a function group consisting of related functions. Next, function groups of {automatic deletion of a part other than document, centering}, {overlay, repeat}, and {page, date} are also checked with regards to whether or not these function groups are detected from 75 percent or more image forming apparatuses 1. When these function groups are detected from 75 percent or more image forming apparatuses 1, these function groups are registered in the function group table 341. Next, the same processing is performed for another image forming apparatus 1 as a reference until the number of the image forming apparatuses 1 as a reference exceeds 25 percent of all of the image forming apparatuses 1. Then, even when the image forming apparatuses 1 in an amount exceeding 25 percent of all of the image forming apparatuses 1 are used as a reference, there is no function detected from 75 percent or more image forming-apparatuses 1. Thus, after 25 percent image forming apparatuses 1 of all of the image forming apparatuses 1 are used as a reference, then the extraction of function groups is completed.

Step S114 of FIG. 10 searches the usage history files 172 of the respective image forming apparatuses 1A to 1D for a function included in a function group newly registered in the above processing to judge, with regards to functions included in the newly registered function group, whether or not any image forming apparatus 1 has a not used function (i.e., a function not found in the search of the usage history file 172). When it is judged that an image forming apparatus 1 does not have a not used function (Step S114; NO), this processing is completed. When it is judged that an image forming apparatus 1 have a not used function (Step S114; YES), then the group number of the function group including an identification ID of the corresponding image forming apparatus 1 and the not used function is registered in the registered table 342 (Step S115). Then, the corresponding image forming apparatus 1 receives, via the communication control section 35, the group number of the function group including the not used function, the data of the function group (data showing the function belonging to the function group), and the data showing the not used function in the function group that are associated to one another. An instruction for registering the function group in the function group table 171 is transmitted (Step S116: registration instruction section).

When the server 3 sends the data for the function group or the like and the registration instruction to the function group table 171, the corresponding image forming apparatuses 1 of the image forming apparatuses 1A to 1D receive, via the communication control section 19, the data for the function group or the like and the registration instruction to the function group table 171 (Step S117) and the function group for which the registration is instructed is registered in the function group table 171 (Step S118). Specifically, data showing the function belonging to the function group that is associated with the received group number is written to the function group table 171. It is noted that a not used function of functions of the received function group is handled so that the head or end of the data of the not used function is attached with a predetermined identifier or the like so that the not used function included in the same function group can be displayed, in an identifiable manner, on an operation screen when other functions of the same function group are displayed on the operation screen.

When one function to be used is selected on the operation display section 12 for each of the image forming apparatuses 1A to 1D, the control section 11 executes the related function display processing (see FIG. 5) described in the first embodiment 1 to perform a searching processing of a function group including the selected function from the function group table 171. When the search result does not show a function group including the selected function, an operation screen corresponding to the selected function is displayed on the operation display section 12. When the search result shows a function group including the selected function on the other hand, the operation screen corresponding to the selected function is displayed on the operation display section 12 And a predetermined region of the operation screen corresponding to the selected function shows a display (see FIG. 6) showing that the apparatus has a function that is in the same function group as that of the selected function and that has been never used (function identified by an identifier).

In this manner, when a related function is used, a function in another image forming apparatus 1 that is used while having a relation with a the related function and that is not used in the image forming apparatus 1 can be displayed on a display screen to show that the apparatus has this function. Thus, a user can recognize the existence of this function.

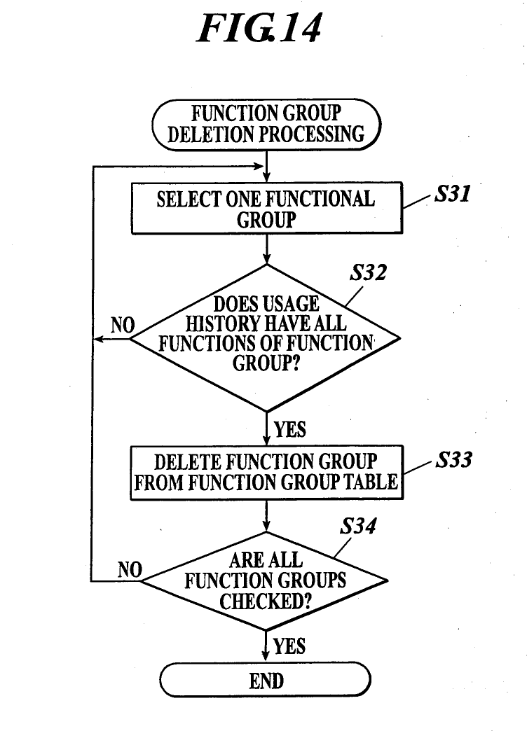

By the way, when an operation screen for the respective functions is displayed and when a user recognizes the existence of a not used function among displayed functions related to the function and the use of the function by the user can be confirmed through the usage history, the display of the function is no more required for the user. A display including unnecessary information causes a complicated screen and thus is not preferred. Thus, each image forming apparatus 1 executes a function group deletion processing shown in FIG. 14 to automatically delete, from the function group table 171, any function group for which the use of all functions in the function group by a user is confirmed. The function group deletion processing is a processing that is performed when a previously set time is reached and that is realized by a software processing by the cooperation of the control section 11 and the function group deletion processing program of the storage section 17.

First, one function group to be subjected to the processing is selected from the function group table 171 (Step S31). Then, the respective functions included in the selected function group are subjected to a search by the usage history file 172 to judge whether or not all functions included in the selected function group are recorded in the usage history in the usage history file 172. When any function not found in the usage history exists and thus is recorded in the usage history (Step S32; NO), the processing returns to Step S31. Then, the next function group is subjected to processings after Step S31. When it is judged that all functions included in the selected function group are recorded in the usage history in the usage history file 172 (Step S32; YES), then the selected function group is deleted from the function group table 171 (Step S33). Specifically, data for the selected function group is deleted from the function group table 171.

Next, whether or not all function groups are checked (i.e., whether or not all function groups are selected as those to be subjected to the processings of Steps S31 to S33) is judged. When an existence of any not-yet-selected function group is judged (Step S34; NO), the processing returns to Step S31 to select the not-yet-selected function group to perform processings after Step S32. When it is judged that all function groups are selected and are subjected to the processings of Steps S31 to S33 (Step S34; YES), this processing is completed.

The above function group deletion processing can delete a function group for which all functions are used from the function group table 171. Thus, an unnecessary display can be prevented.

As described above, according to the image forming system 100, when identification IDs and the usage history files 172 are sent from a plurality of image forming apparatuses 1 connected to the communication network N to the server 3, the server 3 extracts a function group consisting of a plurality of functions that are used while having a relation to one another based on the received identification IDs and usage history files 172 of the plurality of image forming apparatuses 1 to newly register the extracted function group in the function group table 341. Then, functions included in the newly-registered function group are searched in the respective usage history files 172. When a function not found in the search, i.e., any image forming apparatus 1 has a function not included in the usage history, then an instruction for registering the function group in the function group table 171 is sent to the corresponding image forming apparatus 1.

Thus, a user trying to use a certain function can recognize an existence of a function which another image forming apparatus on the communication network N has and which is used together with the function. Thus, the function can be used in a more convenient manner.

Furthermore, each of the image forming apparatuses 1 causes the usage history of a function to be stored in the usage history file 172 so that a function group for which all functions are recorded in the usage history file 172 can be deleted from the function group table 171. Thus, when an operation screen for a function in the function group is displayed at a later stage, other functions in the function group are not displayed. This can prevent a waste such as a case where a related function used by all users is displayed every time.

Furthermore, each of the image forming apparatuses 1 can be structured so that, even when a function group is deleted from the function group table 171, the registered table 342 of the server 3 stores a group number of the function group that has been once registered in the image forming apparatus 1 to be associated with the identification ID of the image forming apparatus 1 and thus has a history of function groups once registered in the image forming apparatus 1. Thus, even when only certain function of the function group is used, the usage history can prevent the function group from being registered again and thus can prevent a wasteful display.

It is noted that the above embodiments have described a preferred example of the image forming system 100 according to the present invention and the invention is not limited to this.

Details and detailed operations of the image forming system 100 and the respective apparatuses constituting the image forming system 100 also can be appropriately changed within a scope of the present invention.

All of the disclosures including the patent specification, the claims, the attached drawings and the abstract of Japanese Patent Application No. 2006-251201 filed Sep. 15, 2006 are herein incorporated by reference.

What is claimed is:

1. An image forming apparatus which has a plurality of functions, comprising:
a display section to display operation screens corresponding to the respective plurality of functions;
an operation section;
a function group storage section to store a function group consisting of a plurality of functions related to one another among the plurality of functions; and
a control section to display on the operation screen, when an operation screen corresponding to one function in the function group stored in the function group storage section is displayed, that the image forming apparatus has the remaining function in the function group.

2. The image forming apparatus of claim 1, wherein the control section deletes the function group selected on the operation section among the function group registered in the function group storage section.

3. The image forming apparatus of claim 1, wherein the control section registers a plurality of functions selected on the operation section as the function group in the function group storage section.

4. The image forming apparatus of claim 1, wherein the control section judges whether or not the function group including one function selected on the operation section is registered in the function group storage section, and when the function group is registered, the control section displays information showing that the image forming apparatus has a remaining function in the function group along with the operation screen of the selected function on the display section.

5. An image forming system comprising a plurality of image forming apparatuses having a plurality of functions and a server, the plurality of image forming apparatuses and the server being connected to one another via communication network, wherein:
each of the image forming apparatuses includes:
a display section to display an operation screen corresponding to the respective plurality of functions
a usage history storage section to store a usage history of the functions;
a transmission section to transmit the usage history stored in the usage history storage section along with identification information about the image forming apparatus to the server;
a control section to store, in a function group storage section, in accordance with a registration instruction from the server, information indicating a function group which is instructed to be registered and functions which are not found in the usage history of the image forming apparatus among functions in the instructed function group, and to display, on the operation screen, when an operation screen corresponding to one function in the function group registered in the function group storage section is displayed, that the image forming apparatus has the remaining function in the function group that is not found in the usage history of the image forming apparatus, and
the server includes:
a reception section to receive the identification information and the usage history from the plurality of image forming apparatuses;
a control section to extract, based on the received usage history of the plurality of image forming apparatuses, a function group consisting of a plurality of functions that are used in relation to one another, and to search a function included in the extracted function group on the usage history received from the respective image forming apparatuses to issue, when the function is not found in the received usage history, the registration instruction for instructing the corresponding image forming apparatus to register, in the function group storage section, the extracted function group and functions of the extracted function group that are not found in the received usage history.

6. The image forming system of claim 5, wherein the control section of the image forming apparatus searches whether or not all functions included in each of function groups stored in the function group storage section is included in the usage history in the usage history storage section, and when the all functions in the function group is included in the usage history, deletes the function group from the function group storage section.

7. A control method of an image forming apparatus which has a plurality of functions and a display section to display operation screens corresponding to the respective plurality of functions, comprising:
registering a function group consisting of a plurality of functions related to one another among the plurality of functions; and
displaying on the operation screen, when an operation screen corresponding to one function in the function group registered in the function group storage section is displayed, that the image forming apparatus has the remaining function in the function group.

8. The control method of claim 7, further comprising:
deleting, the function group selected on the operation section among the function group registered in the function group storage section.
